(19) United States
(12) Patent Application Publication
(10) Pub. No.: US 2008/0172648 A1
(43) Pub. Date: Jul. 17, 2008

(54) Apparatus and method of modeling games

(75) Inventors: Tae Yong Kim, Seoul (KR); Young Joon Chai, Seoul (KR)

Correspondence Address: BACON & THOMAS, PLLC, 625 SLATERS LANE, FOURTH FLOOR, ALEXANDRIA, VA, 22314, US

(73) Assignee: Chung-Ang University Industry-Academy Cooperation Foundation, Seoul (KR)

(21) Appl. No.: 11/979,863

(22) Filed: Nov. 9, 2007

(30) Foreign Application Priority Data
Jan. 17, 2007 (KR) 10-2007-0005368

(51) Int. Cl. G06F 9/44

(52) U.S. Cl. 717/105

(57) ABSTRACT

There are provided an apparatus and a method of modeling a game, which allow a designer to more easily model the game in making the game. The method includes the steps of forming independent game objects as finite state machine (FSMs), forming the FSMs having correlation among the game object FSMs as one interconnected FSM, and transforming the interconnected FSM into a Petri net.

### FIELD OF THE INVENTION

The present invention relates to a method of modeling games, and more particularly, to an apparatus and a method of modeling games, which is capable of more easily and conveniently performing game modeling job in game development.

### BACKGROUND OF THE INVENTION

Recently, rapid development of information and communication technology has led to a great increase in the efficiency of business and a great change in ordinary lifestyle. People use the Internet as a high-speed network, which is widespread. A variety of online game services are provided to Internet users over a computer communication network.

Representative examples of online games include a role playing game (RPG), a real time strategy (RTS) game, an action game, a board game, etc. In the RPG, many players grow characters together based on several events or scenarios and the game progresses according to a given quest.

In general, an online game includes a graphic image section for backgrounds and characters used in the game, a sound section for background music and sound effects, a program section for invoking graphic images and sounds to play the game, and the like. A game making tool effectively combines the sections for convenience of a user.

The game development tool includes a process of modeling a game, a process of analyzing the modeled game, and a process of converting a source code for the modeled game. A finite state machine (hereinafter referred to as “FSM”) and a Petri net are mainly used to model a game.

The FSM is a game model including finite states and is mainly used for modeling a non playable character (NPC) or ongoing state game in an artificial intelligent (AI) engine.

The FSM represents only one state at an instant and has been used for performing a service logic and for modeling conventional games. The FSM has NPCs and objects that have interconnected states for discontinuous conditions. However, the FSM has a limited representation of dependence on states of other objects and is not suitable for simultaneously modeling and drawing states of a variety of game objects because one machine represents only one state.

Recently, a logic of a game with a complex scenario, such as an RPG or an RTS game, needs to simultaneously represent states of several game objects. Actual game objects behave in association with several game objects.

To solve structural problems associated with the FSM, there are proposed models having enhanced simultaneity and concurrent events, such as a Petri net, synchronization trees, event structures, causal automata, and the like.

However, most of the game models are only combinations of simultaneity with any conventional model, for example, by increasing the number of tokens.

Among them, the Petri net is mainly used in engineering to model concurrent events and real-time systems because of its capability of simultaneously representing several states, unlike the FSM. However, it is difficult to design individual objects because the Petri net has no tool for modularity notation. Further, the Petri net is one of mathematical modeling methods, which content makers unaccustomed to engineering cannot easily use.

Therefore, there needs a tool capable of more perfectly designing and analyzing complex states in order to make high-quality games within limited resources and time.

### SUMMARY OF THE INVENTION

It is, therefore, an object of the present invention to provide an apparatus and a method of modeling a game, which are capable of more easily modeling a game that can represent dependence on other objects as well as concurrent events.

Another object of the present invention is to provide an apparatus and a method of modeling a game, which are capable of checking properness of a game model to reduce cost and time required to develop a game.

Still another object of the present invention is to provide an apparatus and a method of modeling a game, which are capable of preventing an error of software after a game is modeled.

Still another object of the present invention is to provide an apparatus and a method of modeling a game, which are capable of simulating transition of game states in a game modeling process for game level balancing.

In accordance with an aspect of the present invention, there is provided an apparatus of modeling a game comprising: a graphic user interface module for modeling game objects in finite state machines (FSMs); and a Petri net transformer for transforming the FSMs of a game model into a Petri net. The apparatus may further comprise a model analyzer for determining properness of the game model by predicting a cost of the game objects.

In accordance with another aspect of the present invention, there is provided a method of modeling a game, comprising the steps of: forming game objects into interconnected finite state machines (FSMs); and transforming the interconnected FSM into a Petri net.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram illustrating a game modeling apparatus in accordance with the present invention;

FIG. 2 illustrates a method of modeling a game in accordance with the present invention;

FIGS. 3A and 3B illustrate a game object having an interconnected FSM designed with transition dependence;

FIGS. 4A and 4B illustrate a game object having an interconnected FSM designed with state dependence;

FIG. 5 illustrates a method of drawing an interconnected FSM and a Petri net;

FIG. 6 illustrates a graph of a Petri net transformed from an interconnected FSM; and

FIGS. 7A and 7B illustrate a cost calculating concept for a game object depending on state transition.

### DETAILED DESCRIPTION OF THE EMBODIMENTS

Hereinafter, embodiments of the present invention will be described in detail with reference to the accompanying drawings so that they can be readily implemented by those skilled in the art.

The present invention provides a method of forming one interconnected finite state machines (FSMs) by connecting FSMs of game objects to one another based on their dependence, and transforming the interconnected FSMs into a Petri net in developing a game.

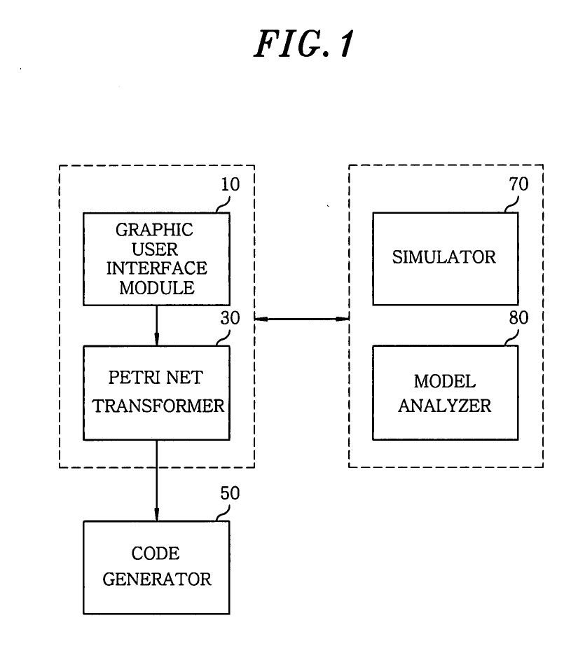

FIG. 1 is a block diagram illustrating a game modeling apparatus in accordance with the present invention.

Referring to FIG. 1, a game modeling apparatus includes a graphic user interface module 10 for modeling a game object by a user, e.g., a game designer, a Petri net transformer 30 for transforming a game model into a Petri net, a code generator 50 for converting the game model into a source code, a simulator 70 for performing simulation of the game model, and a model analyzer 80 for determining properness of the game model.

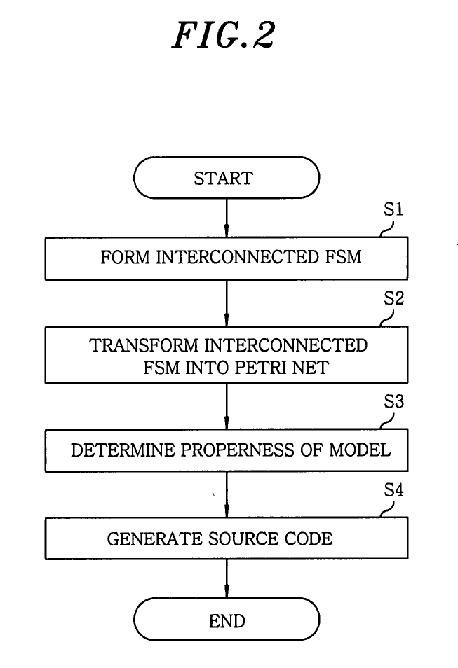

A process of modeling a game by using the game modeling apparatus is shown in FIG. 2.

First, a plurality of independently-designed game objects are formed as FSMs and the FSMs are formed as one interconnected FSM by the graphic user interface module 10 (S1).

The interconnected FSM is transformed into one Petri net by the Petri net transformer 30 (S3).

Meanwhile, state transition of each of the game objects is simulated by the simulator 70 prior to obtaining the game model. This simulation contributes to game level balancing. A cost of the game objects arriving at a specific state is calculated by the model analyzer 80 and utilized as a material in a game balancing to determine properness of the obtained game model (S5).

If it is determined that the game model is proper, a source code of the game model is generated by using the code generator 50 (S7).

The method of modeling a game will now be described in greater detail.

First, the process of forming the interconnected FSM in process S1 is performed.

If the independently-designed game objects have correlation therebetween, transition of one object may depend on either transition of another object (transition dependence) or a current state of another object (state dependence).

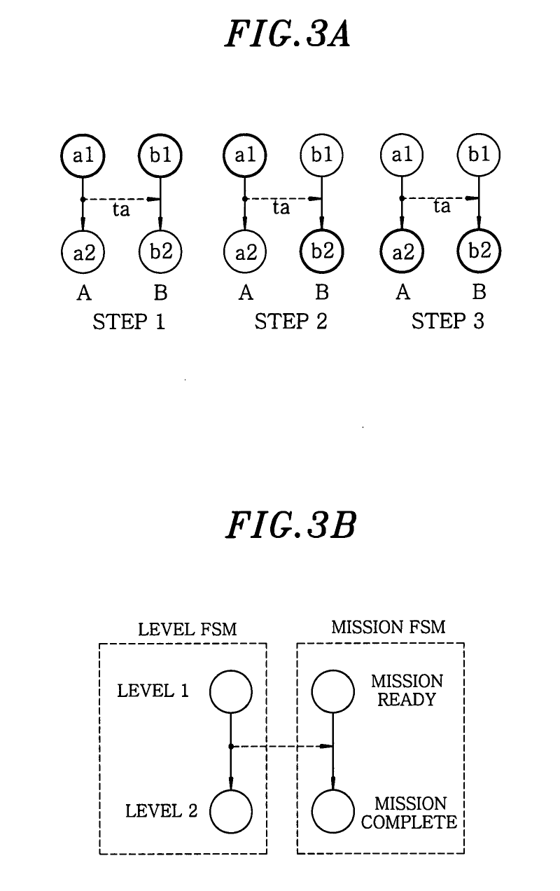

FIG. 3A shows a transition dependence process. a plurality of different objects, e.g., objects A and B, are produced by a game designer as independent FSMs and both objects are connected to each other based on their dependence, to thereby obtain one interconnected FSM.

As shown in FIG. 3A, initial levels of the objects A and B are ‘a1’ and ‘b1’ as indicated by solid circles (Step 1). In this case, when the state of the object B changes from ‘b1’ to ‘b2’ (Step 2), a transition dependence arc (ta) becomes true and the state of the object A can arrive at ‘a2’ (Step 3). That is, the state transition of the object A depends on the state transition of the object B.

FIG. 3B shows a level upgrade model of a player appearing in a game, such as a role playing game (RPG), which is designed by using the principle illustrated in FIG. 3A. As shown in FIG. 3B, a state of a mission FSM must first transition to ‘Mission Complete’ in order for a state of a level FSM of the player to transition from ‘Level 1’ to ‘Level 2’.

Such transition dependence may be applied to design of a change-of-occupation system of a game character having multiple stories or occupations.

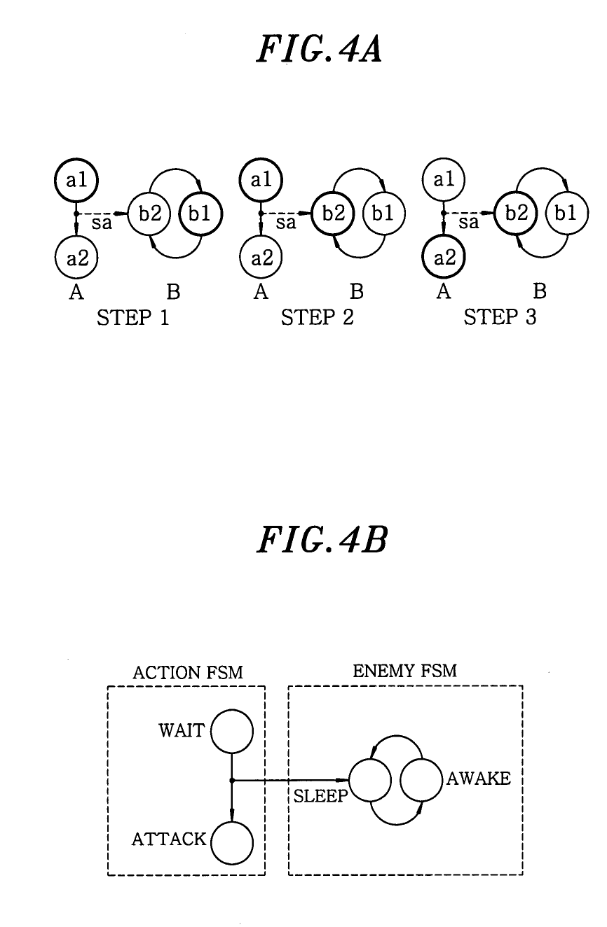

FIG. 4A shows a state dependence process.

As shown in FIG. 4A, initial levels of objects A and B are ‘a1’ and ‘b1’ as indicated by solid circles (Step 1). The object A depends on a state of the object B. Accordingly, when the state of the object B becomes ‘b2’ (Step 2), the state dependence arc (SA) becomes true and a state of the object A transitions from ‘a1’ to ‘a2’ (Step 3).

FIG. 4B illustrates an FSM of non playable characters (NPCs) designed by using the principle illustrated in FIG. 4A. As shown in FIG. 4B, when an enemy FSM remains in a ‘sleep’ state, an action FSM can transition to an ‘attack’ state. On the contrary, when the enemy FSM is ‘awake’, the action FSM cannot transition to the ‘attack’ state.

The dependence on the state of another FSM may be mainly applied to design of artificial intelligent (AI) of a game object.

Thus, when game objects have correlation therebetween, transition of one object depends on transition of another object. The game designer can determine whether a game object can transition to a next state depending on a circumstance or a current state of another object.

Through the above process, different object FSMs are formed as one interconnected FSMS. The interconnected FSMs may be defined as following TABLE:

TABLE
(Definition of interconnected FSMs)

Definition 1. Finite state machine F is a 4-tuple (Σ, S, s₀, δ) where Σ is a finite non
empty set of symbols of F, S is a finite non empty set of states, s₀ is an initial state and
δ is the state transition function: δ: S × Σ → S.
Definition 2. Given a finite set Q = {Fₗ,...,Fₙ} of finite state machines with mutually
distinct state spaces S_{F}ᵢ.
Definition 3. Transition frequency function H: δ →{0,1,2,..}, the number of
frequency of a δ transition.
Definition 4. Active test function M: S→{true, false}, If s ∈ S is a current state, M(s)
returns true.
Definition 5. Transition dependence function R: ∪_{F}_{ₜ}_{∈Q} δ_{F}_{ₜ} → ∪_{F}_{_{f}}_{∈Q} δ_{F}_{_{f}}
Different FSMs is connected: i ≠ j
(∃d∈∪_{F}_{_{f}}_{∈Q} δ_{F}_{_{f}}) [symbol] (H(d) > 0) then true else false.
R is depicted by a dotted line from a transition to another transition on a graph and
we call it a transition dependence arc.
Definition 6. State dependence function W: ∪_{F}_{ₜ}_{∈Q} δ_{F}_{ₜ} → ∪_{F}_{ⱼ}_{∈Q} S_{F}_{ⱼ}
Different FSMs is connected: i ≠ j
(∃q∈∪_{F}_{_{f}}_{∈Q} S_{F}_{_{f}}) [symbol] (M(q) = true) then true else false
W is depicted by a dotted line from a transition to another state on a graph and we
call it a state dependence arc.
Definition 7. Interconnected FSMs N is a 3-tuple (Q, Y, Z). Q is a finite non empty
set of FSMs. Y is a set of a transition dependence function R and Z is a set of a state
dependence function W. To change a state, the input event that is need occurs at the transition
and dependence function should return true.

A process S3 of transforming the interconnected FSMs into a Petri net will now be described. It may be necessary for the interconnected FSMs to be transformed into the Petri net in order to simultaneously represent states of a variety of game objects.

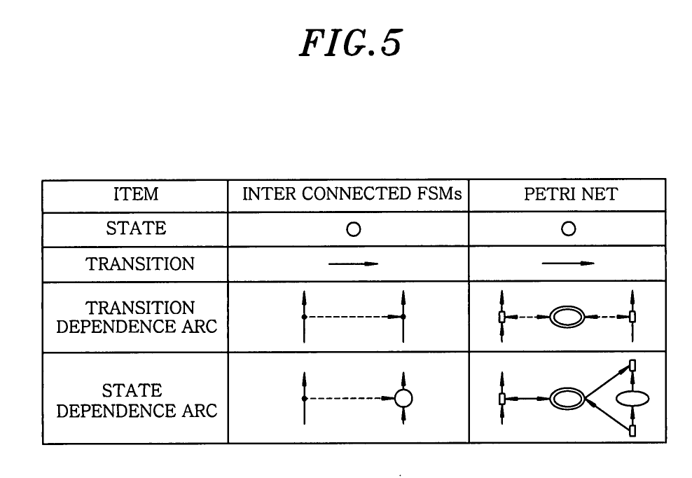

FIG. 5 shows a Petri-net drawing method that corresponds to an interconnected-FSM drawing method.

An item table including tool items for the Petri net corresponding to tool items of the interconnected FSM is formed as shown in FIG. 5 and stored in the Petri net transformer 30 in advance.

The interconnected FSM is transformed into the Petri net according to a Petri net drawing method by referring to the item table.

If there is a dependence on a state or transition of another object, condition states (flags) are used to store a current state or past transition history of objects, as indicated by a dual line circle.

A two-way arc is used to constantly hold the condition state. When a state of one object is directly associated with a state of another object, the condition state holds a token in synchronization with a current state of the object.

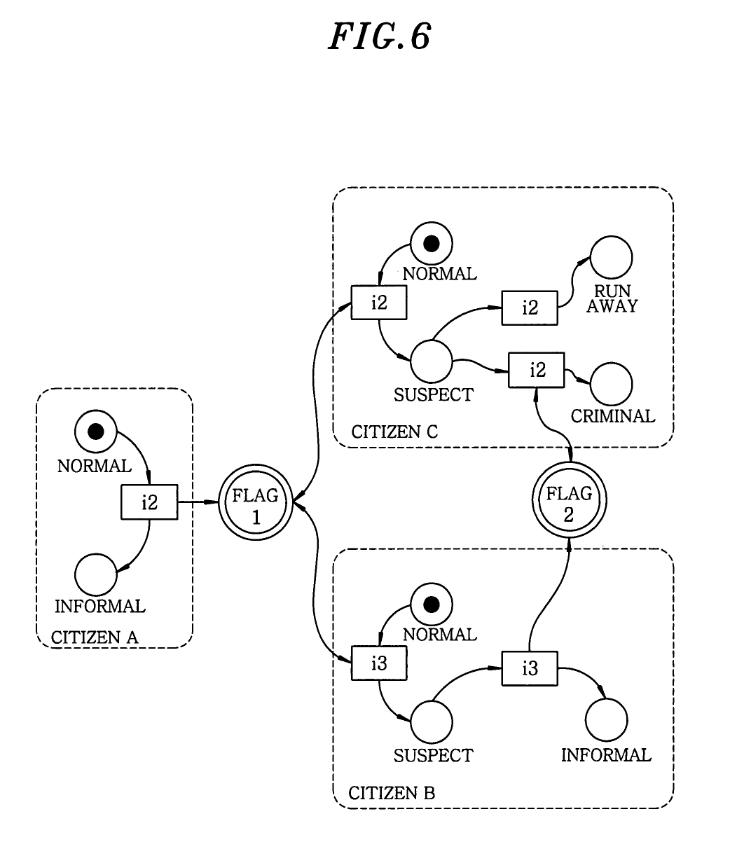

FIG. 6 shows a Petri net transformed by using a notation corresponding to an interconnected FSM, in which only a transition dependence arc is used.

The Petri net shown in FIG. 6 is based on the following scenario that may occur in a game such as an RPG, in which an interconnected FSM is designed to obtain the Petri net by using the drawing method of FIG. 5.

1) A goal of a player is to identify which one of citizens A, B and C is a criminal.

2) The citizen A knows that the citizens B and C are suspects. The citizen A will provide this information to the player when meeting the player (i1). (‘Flag1’ holds a token that may enable transition to another state.)

3) It is almost certain that the citizen B would be a suspect, based on the information from the citizen A. The citizen B will provide information that the citizen C is the criminal, when meeting the player (i3). (‘Flag2’ holds a token that may enable transition to another state.)

4) It is almost certain that the citizen C would be the suspect. The citizen C runs away before the player meets the citizen B (i2).

5) It is almost certain that the citizen C would be the suspect. The citizen C confesses to the player that he or she is the criminal when the player has met the citizen B (i2).

The interconnected FSM is transformed into the Petri net by causing the Petri net drawing method of FIG. 5 to correspond to the interconnected FSM.

As the process S5 of determining the properness of the Petri net model, a process of calculating a game modeling cost is necessary. Adjustment of game balancing is critical in making a game because of its influence on the amusement and goal of gamers.

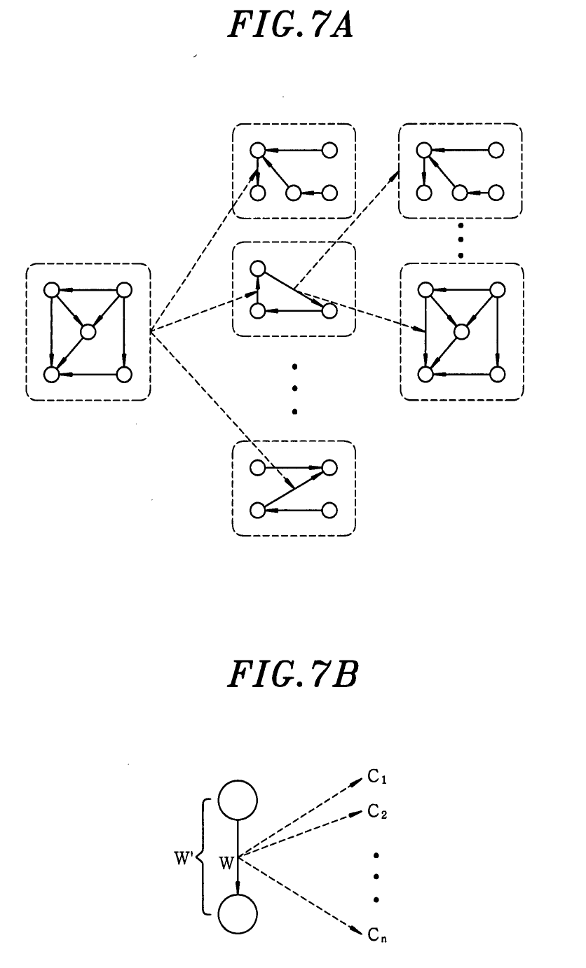

Game modeling with state dependence will now be described by way of example with reference to FIGS. 7A and 7B.

FIG. 7A shows game objects that depend on state transition, and FIG. 7B shows a cost calculating method that considers state transition of another object.

As shown in FIGS. 7A and 7B, since each game object depends on state transitions of other objects, sub-costs due to the state transitions of other objects on which respective game objects depend may be caused in calculating the game modeling cost.

Accordingly, a total cost w′ is calculated by summing a cost w of a single object and state transition costs Max (c₁, c₂, . . . , cₙ) of other objects, which can be represented as follows:

w′=w+Max (c₁, c₂, . . . , cₙ) EQUATION (1)

The calculated game modeling cost is used to evaluate the properness of the game. If the game model is determined to be proper through the properness evaluation process, a source code is generated.

In the present invention, the method of forming several FSMs as one interconnected FSM and transforming the interconnected FSM into the Petri net is used to utilize both a conventional simple FSM modeling scheme and a Petri net that is capable of simultaneously representing states of a variety of game objects.

A method of modeling a game according to the present invention may be implemented by program instructions, which may be executed by a variety of computer systems, and recorded on a computer readable medium. The computer readable medium may include a sequence of instructions, data files, data structures and the like solely or in combination. The program instructions recorded on the medium may be particularly designed and produced for the present invention or may be program instructions known to those skilled in the art. Examples of the computer readable recording medium include magnetic media such as a hard disk, a floppy disk and a magnetic tape; optical media such as a compact disk-read only memory (CD-ROM) and a digital versatile disc (DVD); magneto-optical media such as a floptical disk; and a read only memory (ROM), a random access memory (RAM), and a flash memory, which are hardware devices particularly configured to store and execute program instructions. Examples of program instructions include high-level language codes that may be executed by a computer using an interpreter, as well as machine language codes as produced by a compiler. The above hardware device may be configured to operate as one or more software modules to perform operation of the present invention and vice versa.

According to the apparatus and method of modeling a game of the present invention as described above, both advantages of the FSM and the Petri net can be utilized by providing the game modeling method in which the FSM is formed and then transformed into the Petri net. That is, a game can be made in a simple manner and concurrent events can be represented.

Further, a total cost of a game object is calculated based on transition of another object on which the game object depends, thereby more accurately predicting a game modeling cost.

In addition, the game modeling cost prediction provided by the present invention is utilized as a game balancing material, which contributes to making a well-balanced game. This can increase satisfaction of gamers as well as game designers.

While the invention has been shown and described with respect to the preferred embodiments, it will be understood by those skilled in the art that various changes and modifications may be made without departing from the scope of the invention as defined in the following claims.

What is claimed is:

1. An apparatus of modeling a game, comprising:
a graphic user interface module for modeling game objects in finite state machines (FSMs); and
a Petri net transformer for transforming the FSMs of a game model into a Petri net.

2. The apparatus of claim 1, wherein the graphic user interface module forms a plurality of FSMs with one interconnected FSMS, the plurality of FSMs having correlation mutually.

3. The apparatus of claim 1, wherein the Petri net transformer comprises a unit for storing an item table including tool items for the Petri net corresponding to tool items of the interconnected FSMs.

4. The apparatus of claim 1, further comprising a model analyzer for determining properness of the game model.

5. The apparatus of claim 4, wherein the model analyzer comprises a unit for calculating a cost of the interconnected FSMs.

6. A method of modeling a game, comprising:
(a) forming game objects into interconnected finite state machines (FSMs); and
(b) transforming the interconnected FSM into a Petri net.

7. The method of claim 6, wherein the step (a) comprises the steps of:
forming the game objects into FSMs; and
forming the FSMs of the game object into the interconnected FSMS.

8. The method of claim 7, wherein the step (b) comprises forming the FSMs of the game objects into an interconnected FSM having transition dependence.

9. The method of claim 7, wherein the step of forming the FSMs of the game objects into the interconnected FSMs comprises forming the FSMs of the game objects into an interconnected FSM having state dependence.

10. The method of claim 6, wherein the step (b) comprises transforming items of the interconnected FSM into the Petri net, based on an item table including tool items for the Petri net corresponding to tool items of the interconnected FSM.

11. The method of claim 10, wherein when there is a dependence on a state or transition of other objects, condition states (flags) are used to store a current state or past transition history of objects.

12. The method of claim 11, wherein the condition state is held by using a two-way arc.

13. The method of claim 6, further comprising a step (c) determining properness of the game model by calculating a cost w′ due to transition of the game objects.

14. The method of claim 13, wherein the cost w′ for a specific game object in the step (c) is calculated by summing a cost w due to transition of the game objects and costs Max (c₁, c₂, . . . , cₙ) due to transitions of other objects on which the game object depends as follows:
w′=w+Max (c₁, c₂, . . . , cₙ).

15. A computer readable recording medium having a program recorded thereon for performing a method according to any one of claims 6 to 14.
